(19) United States
(12) Patent Application Publication
(10) Pub. No.: US 2004/0061292 A1
(43) Pub. Date: Apr. 1, 2004

(54) Articulation compensated hydraulic suspension system

(76) Inventor: Everett Hall, Farmington Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/256,703

(22) Filed: Sep. 27, 2002

(51) Int. Cl. B60G 17/005; B60G 17/01

(52) U.S. Cl. 280/5.507

(57) ABSTRACT

A suspension system comprises a vehicle frame having a front and rear sections. At least a first hydraulic actuator and a second hydraulic actuator are located in one of the sections. A piston defines a first fluid chamber and a second fluid chamber in each of the actuators. A rod is disposed in each second of fluid chamber. The first fluid chamber of the first actuator is in fluid communication with the second fluid chamber of the second hydraulic actuator.

### BACKGROUND OF THE INVENTION

This invention relates to a hydraulic vehicle suspension system.

Hydraulic suspension systems exist that provide an alternative suspension for spring, sway bar, and shock assemblies found on many vehicles. These systems may employ a hydraulic cylinder with a piston and rod disposed in the cylinder. The hydraulic cylinder acts like both a spring and a shock absorber for a wheel of a vehicle. The piston divides the cylinder into two fluid chambers. One fluid chamber houses the rod while the other chamber communicates fluid to a fluid reservoir, known as an accumulator. The accumulator serves to act as the “spring” of the assembly. When the wheel of the vehicle experiences a road input, the rod drives the piston into the cylinder, causing fluid to flow into the accumulator. A valve disposed between the accumulator and the chamber serves to act as a dampening mechanism or “shock absorber,” by limiting flow of fluid into the accumulator.

Each of these hydraulic cylinders may be linked to each other. Such an arrangement may permit changes in one hydraulic cylinder to affect the operation of another. Indeed, one such system proposes linking a front wheel hydraulic cylinder diagonally with a rear wheel hydraulic cylinder. In such a configuration, for example, movement of the left front tire causes a corresponding movement of the right rear tire, to thereby improve road handling of a vehicle.

However, because the front hydraulic cylinders are linked to the rear hydraulic cylinders, there is great difficulty in adjusting the front hydraulic cylinders without affecting the tuning of the rear hydraulic cylinders. Moreover, the diagonal linking across the vehicle frame of hydraulic cylinders complicates control of the hydraulic suspension system against vehicle rollover. Finally, adjusting vehicle roll stiffness for the suspension is also made more difficult by this diagonal link between hydraulic cylinders.

A need therefore exists for a hydraulic system that is easier to tune and permits simplified control of the system against vehicle rollover.

### SUMMARY OF THE INVENTION

The inventive suspension system permits independent tuning of the front suspension from the rear suspension and facilitates control of the system against vehicle rollover. Like known hydraulic suspension systems, the inventive system employs a pair of hydraulic cylinders located in each of the front and rear sections of the vehicle. Each hydraulic cylinder is linked to a vehicle wheel and provides hydraulic “spring” and “dampening” for each wheel through associated accumulators and valves.

In contrast to existing hydraulic systems, however, the invention links the left front hydraulic cylinder with the right front hydraulic cylinder and the left rear hydraulic cylinder with the right rear hydraulic cylinder. The front hydraulic cylinders are then linked with the rear hydraulic cylinders through a hydraulic coupling device known as an articulation compensator as done with the inventive suspension. By terminating fluid flow from the hydraulic cylinders to the articulation compensator, as done with the inventive suspension, the front hydraulic cylinders are decoupled from the rear hydraulic cylinders thereby permitting independent ride tuning of the front suspension from the rear suspension. Flow to the articulation compensator may then be returned to fine tune roll stiffness distribution between front and rear suspensions.

The piston of each hydraulic cylinder may define a first fluid chamber and a second fluid chamber. The second fluid chamber may house the rod of the piston. In the front of the vehicle, the first fluid chamber of the left front hydraulic cylinder is in fluid communication with the second fluid chamber of the right front hydraulic cylinder. Moreover, the first fluid chamber of the right front hydraulic cylinder may be in fluid communication with the second fluid chamber of the left front hydraulic cylinder. This crisscross connection of front fluid chambers permits the movement of the piston into the left front hydraulic cylinder to encourage movement of the piston of the right front hydraulic cylinder into the cylinder. Movement of a piston out of the left front hydraulic cylinder encourages movement of the piston out of the right front hydraulic cylinder. During a vehicle turn, such an arrangement results in a stiffer vehicle suspension.

As mentioned, the front suspension may be coupled to the rear suspension through the articulation compensator. The articulation compensator may hydraulically link one of the front hydraulic cylinders with one of the rear hydraulic cylinders. The articulation compensator may comprise two major chambers, each with two subchambers. One major chamber, a front linked chamber, may be linked to the front hydraulic cylinders while the other major chamber, a rear linked chamber, may be linked to the rear hydraulic cylinders. Moreover, one of the subchambers of the front linked major chamber may be in fluid communication with the left front hydraulic cylinder and the other subchamber may be hydraulically linked to the right front hydraulic cylinder. The subehambers of the rear linked major chamber may be also linked to respective right rear and left rear hydraulic cylinders.

The front linked chamber and the rear linked chamber may each have a piston that defines a wall of each of the subchambers. The two pistons are linked in movement so that changes in pressure of, say, the front linked piston result in movement of the rear linked piston thereby coupling front suspension to rear suspension. The front linked piston may have a different size from the rear linked piston resulting in the ability to adjust suspension roll stiffness between front and rear suspensions based on this size difference.

The suspension system may be tuned between the front vehicle section and the rear vehicle section through the articulation compensator. Specifically, by altering the size of the first piston relative to the second piston, suspension roll stiffness may be increased between the front and rear sections of the vehicle. Either piston may be adjusted relative to the other piston and may be adjusted by altering the relative surface area between the front linked piston and the rear linked piston.

A valve may serve to restrict or shutoff fluid flow between the articulation compensator and the hydraulic cylinders. A control unit may control the valve and may receive data from a sensor or vehicle sensors to control the valve. By actuating this valve to shutoff fluid flow to the articulation compensator, the front hydraulic cylinders are decoupled from the rear hydraulic cylinders. This feature not only allows independent tuning of front and rear suspensions but reduces the prospect of vehicle rollover under certain conditions.

The ride height of the vehicle may be increased or decreased through a height adjustment valves that permits the introduction or depletion of hydraulic fluid into the system. In this way, the suspension may be raised or lowered to suit the particular terrain encountered by the vehicle. A pump and fluid reservoir may serve to introduce or reduce fluid levels.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 illustrates a schematic representation of the inventive hydraulic system, showing hydraulic actuators, coupler, valves, and control unit.

FIG. 2 illustrates hydraulic actuator of FIG. 1, detailing the piston, rod and dimensions of rod.

FIG. 3 illustrates the piston of FIG. 2.

FIG. 4 illustrates front link piston and rear link piston of FIG. 1.

FIG. 5 illustrates an alternative view of the pistons of FIG. 4.

### DETAILED DESCRIPTION OF THE PREFERRED EMBODIMENT

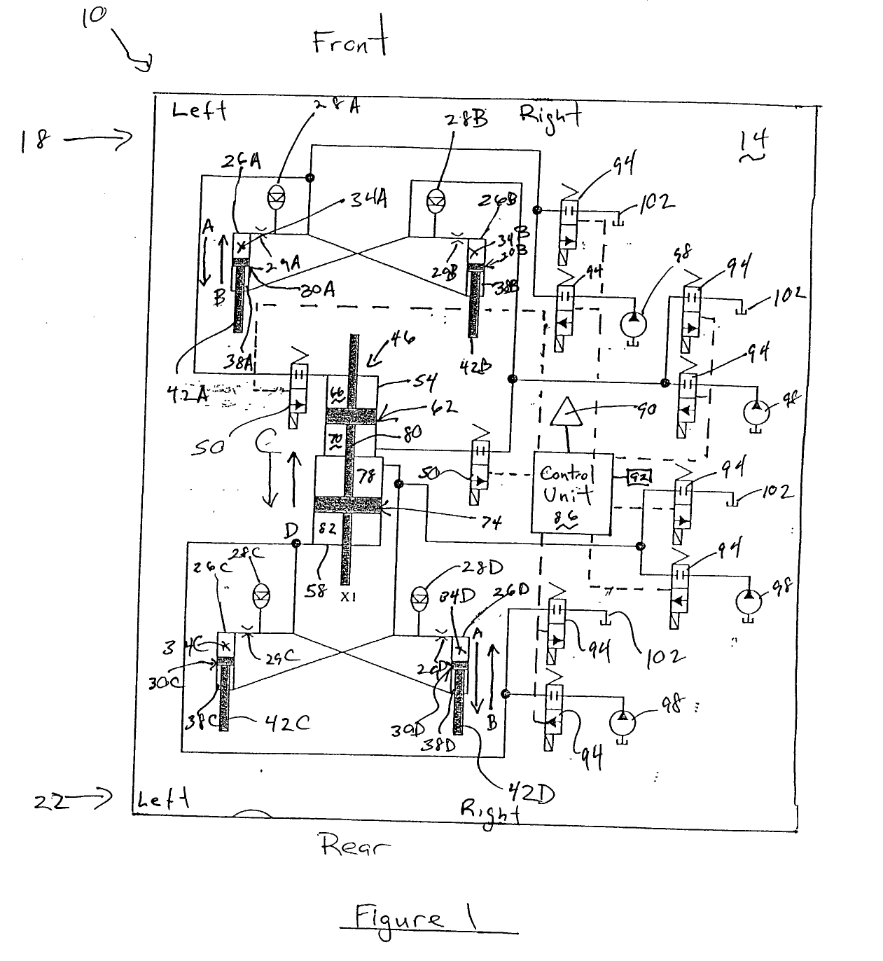

FIG. 1 illustrates a schematic representation of inventive hydraulic system 10. As known, hydraulic actuators 26A, 26B, 26C and 26D are mounted to vehicle frame 14. Hydraulic actuators 26A, 26B, 26C and 26D, such as cylinders, have pistons 30A, 30B, 30C and 30D disposed in each cylinder, to define respective first fluid chambers 34A, 34B, 34C and 34D and respective second fluid chambers 38A, 38B, 38C and 38D. Second fluid chambers have respective rods 42A, 42B, 42C and 42D extending through the chamber to be attached to respective pistons 30A, 30B, 30C and 30D. Hydraulic actuators 26A, 26B, 26C and 26D are actuable along arrow A or arrow B and are linked to the wheels of a vehicle by known techniques to follow along the path of arrow A or arrow B or other paths determined by the manufacture.

Also known, hydraulic actuators 26A, 26B, 26C and 26D are in fluid communication with respective damping valves 29A, 29B, 29C and 29D, which themselves are in fluid communications with respective hydraulic accumulators 28A, 28B, 28C and 28D. Compression of pistons 30A, 30B, 30C and 30D along arrow B causes fluid to pass through respective dampening valves 29A, 29B, 29C and 29D, which act like a shock absorber by restricting rate of fluid flow into and out of hydraulic actuators. Commercially available hydraulic accumulators 28A, 28B, 28C and 28D act as a “spring” element so that pistons 30A, 30B, 30C and 30D and rods 42A, 42B, 42C and 42D act like a spring and shock absorber suspension system. The use of hydraulic actuators 26A, 26B, 26C and 26D in this manner are well known.

In contrast to existing hydraulic suspension systems, inventive suspension system 10 employs a unique technique for coupling hydraulic actuator 26A to hydraulic actuator 26B of front section 18 of vehicle 14 and hydraulic actuator 26C to hydraulic actuator 26D of rear section 22 of vehicle 14. Moreover, left front hydraulic actuator 26A and right front hydraulic actuator 26B are coupled hydraulically through a novel coupler 46, an articulation compensator, to left rear hydraulic actuator 26C and right rear hydraulic actuator 26D. As detailed below, the inventive technique for communicating hydraulic fluid between hydraulic actuators 26A, 26B, 26C and 26D permits front hydraulic actuators 26A and 26B to be tuned independently of the tuning of rear hydraulic actuators 26C and 26D for both ride and roll characteristics. Indeed, the unique design of coupler 46 promotes the roll stiffness of front hydraulic actuators 26A, 26B to be adjusted relative to rear hydraulic actuators 26C, 26D for wheel stiffness. Inventive hydraulic suspension system 10 may thereby provide better handling characteristics with a softer ride. Moreover, the use of coupler valves 50 provides not only a simple and inexpensive way to adjust front and rear suspensions independently but also to reduce the risk of vehicle rollover.

Specifically, left hydraulic actuator 26A has first fluid chamber 34A in fluid communication with second chamber 38B of right front hydraulic actuator 26B. Second fluid chamber 38A is in fluid communication with first fluid chamber 34B of right front actuator 26B. As a consequence of this design, movement of rod 38A and piston 30A along arrow B, say when vehicle wheel is depressed by road, causes compression of first fluid chamber 34A and displacement of hydraulic fluid into second fluid chamber 38B thereby encouraging movement of piston 30B and rod 38B also along arrow B. Conversely, movement of rod 42A along arrow A displaces fluid from second fluid chamber 38A to first fluid chamber 34B of right front hydraulic actuator 26B, thereby encouraging movement of piston 30B and rod 42B along arrow A. In this way, left front hydraulic actuator 26A and right front hydraulic actuator 26B are hydraulically coupled to promote movement of piston 30A and rod 38A and piston 30B and rod 42B along the same direction thereby promoting vehicle stability during a vehicle turn. Rear left hydraulic actuator 26C and rear right hydraulic actuator 26D are hydraulically coupled in the same manner with first fluid chamber 34C in fluid communication with second fluid chamber 38D and second fluid chamber 38C in fluid communication with first fluid chamber 34D. Rear hydraulic actuators 26C and 26D accordingly operate in a similar manner with respect to each other as front hydraulic actuators 26A and 26B. Front hydraulic actuators 26A, 26B and rear hydraulic actuators 26C and 26D are thus passively linked to each other without the need for any active elements, such as a hydraulic pump. This design permits independent tuning of front hydraulic actuators 26A, 26B from rear hydraulic actuators 26C, 26D, because front hydraulic actuators are not in fluid communication with rear hydraulic actuators.

Front hydraulic actuators 26A and 26B are coupled to rear hydraulic actuators 26C and 26D. Hydraulic coupling is provided by coupler 46. Coupler 46 comprises front link piston 62 and rear linked piston 74 linked by rod 80. Movement of front linked piston 62 along arrow C causes movement of rear linked piston 74 along arrow C. Conversely, movement of piston 62 along arrow D causes movement of piston 74 along arrow D. Piston 62 is disposed within front linked chamber 54 while piston 74 is disposed within rear linked chamber 58. Front linked chamber 54 is preferably sealed from rear linked chamber 58 so that only movement of shaft 80 causes piston 62 to affect piston 74.

Front linked chamber 54 comprises first front linked subchamber 66 and second front linked chamber 70. Piston 62 defines a wall of each of the chambers. Also, rear linked chamber 58 comprises first rear linked subchamber 78 and second rear linked subchamber 82, each subchamber divided by piston 74.

First fluid chamber 34A of left front hydraulic actuator 26A is in fluid communication through shutoff valve 50 with first front linked subchamber 66. Second fluid chamber 38B of right front hydraulic actuator 26B is also in fluid communication with subchamber 66. First fluid chamber 34B of right front hydraulic actuator 26B is in fluid communication with second front linked subchamber 70. Also in fluid communication with subchamber 70 is second fluid chamber 38A of left front hydraulic actuator 26A. Fluid chambers 34B, 38A also pass through shutoff valve 50. Shutoff valves 50 control fluid flow to subchambers 66 and 70.

First fluid chamber 34C of left rear hydraulic actuator 26C is in fluid communication with second rear linked subchamber 82. Second fluid chamber 38D is also in fluid communication with subchamber 82. Second fluid chamber 38D is also in fluid communication with subchamber 82. First fluid chamber 34D of right rear hydraulic actuator 26D is in fluid communication with first rear linked subchamber 78. Also, second fluid chamber 38C communicates with subchamber 78.

As a consequence of this design, assuming valves 50 are open, when both front rods 42A, 42B are depressed with equal force along arrow B, hydraulic fluid is communicated to both first front linked subchamber 66 and second front linked subchamber 70, then hydraulic fluid within first front linked subchamber 66 and second front linked subchamber 70 seek to expand in opposite directions, say along arrow C and arrow D, so that piston 62 remains in the same position due to equal hydraulic pressure in first front link subchamber 66 and second front link subchamber 70. Accordingly, same force movement of rods 42A and 42B along arrow A discourages movement of piston 62 due to equal pressure in subchambers 70 and 66. Rear hydraulic actuators 26C and 26D act in the same manner through subchamber 78 and 82.

Thus, in the event both front wheels are bumped upward with the same force, there is insignificant effect on rear hydraulic actuators 26C and 26D, thus decoupling rear hydraulic actuators 26C and 26D from front hydraulic actuator 26A and 26B. Also, in the event rear tires which correspond to rear hydraulic actuators 26C and 26D are bumped with equal force, say along arrow B, rear hydraulic actuators 26C, 26D are decoupled and have no significant effect on front hydraulic actuators 26A and 26B. In this way, vehicle ride is improved.

In the event one wheel connected to one hydraulic actuator, say left front hydraulic actuator 26A, is bumped with unequal force relative to right front hydraulic actuator 26B, say along arrow B, hydraulic pressure in front linked subchamber 66 will tend to be greater than fluid pressure within front linked subchamber 70 causing movement of front linked piston 62, shaft 80, and rear linked piston 74 along arrow C increasing pressure in second rear linked subchamber 82 and decreasing pressure in first rear linked subchamber 78. With decreased pressure in first rear linked subchamber 78, fluid pressure in first fluid chamber 34D is also decreased promoting movement of piston 30D and rod 42D and associated wheel along arrow B. Also, pressure within first fluid chamber 34C of left rear hydraulic actuator 26C is increased, encouraging movement of piston 30C and rod 42C along arrow A. In this way, front left hydraulic actuator 26A is encouraged to articulate and move in the same direction, i.e., along arrow B, with right rear hydraulic actuator 26D.

On the other hand, if piston 42A extends along the direction of arrow A, fluid pressure in first fluid chamber 34A decreases causing a decrease in fluid pressure in first front linked subchamber 66, resulting in movement of pistons 62 and 74 along arrow D. This results in an increase in fluid pressure in first rear linked subchamber 78 and a decrease in pressure in a second rear linked subchamber 82. Consequently, fluid pressure in first fluid chamber 34D will increase and fluid pressure in first fluid chamber 34C will decrease. The net results will be to encourage movement of piston 38D and rod 42D along arrow A and piston 30C and shaft 42C along arrow B. Rear hydraulic actuators 26C, 26D respond to unequal force inputs in similar fashion. In this way, inventive hydraulic system 10 encourages wheel articulation.

Certain ride conditions may result in vehicle rollover. For example, during wheel articulation, vehicle frame 14 may receive excessive force from across left front to right rear or right front to left rear such that wheel articulation is undesirable. Accordingly, vehicle frame 14 is provided with sensor 90 which detects acceleration from front to rear and from side to side of vehicle frame 14. This information is communicated to control unit 86, which controls actuation of valve 50. Valve 50 controls flow of fluid from front hydraulic actuators 26A and 26B to front linked chamber 54. In the event rollover conditions are sensed by sensor 90 and detected by control unit 86, control unit 86 shuts off valves 50 and cuts off fluid flow from front hydraulic actuators 26A and 26B to front link chamber 54. In this way, movement of one front hydraulic actuator, say hydraulic actuator 26A, does not encourage corresponding movement of rear hydraulic actuator, say right rear hydraulic actuator 34D, along the same path. Thus, articulation of the suspension is shutoff to prevent vehicle rollover.

In addition, instances may also arise where the ride height of vehicle frame 14 must be increased or decreased. This can be achieved simply through height adjustment valves 94, which are in fluid communication with hydraulic fluid reservoir 102 and pump 98. When increased ride height is needed, switch 92 may be actuated by a user who desires to increase vehicle height. The actuation of switch 92 is communicated to control unit 86 which causes ride height adjustment valves 94 to open and permit flow of hydraulic fluid into each of the hydraulic actuators 26A, 26B, 26C and 26D via pump 98. Fluid levels are increased to promote movement of rods 42A, 42B, 42C and 42D along arrow A. Conversely, to reduce vehicle height, switch 92 may be actuated, in say an opposite direction, so that valves 94 are open to encourage the flow of hydraulic fluid from hydraulic actuators 26A, 26B, 26C and 26D to fluid reservoirs 102. Once fluid levels are at the desired level, valves 94 are closed.

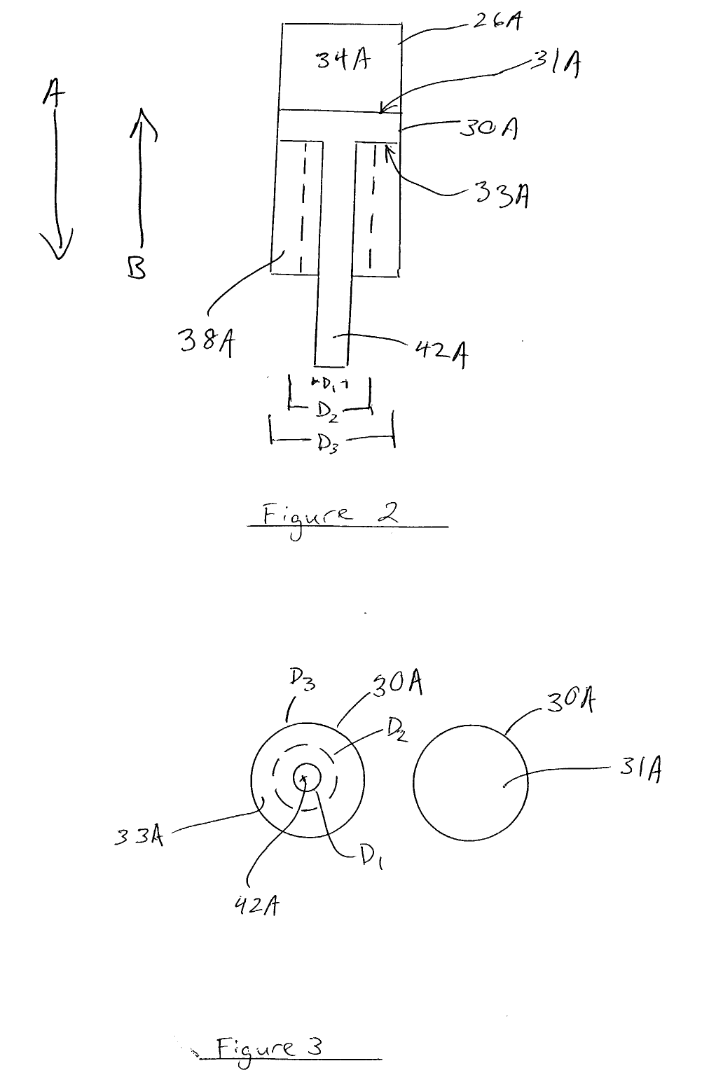

FIGS. 2 and 3 illustrate how roll stiffness may be adjusted to a desired level. Specifically, as shown in FIG. 2, left front hydraulic actuator 26A comprises first fluid chamber 34A and second fluid chamber 38A defined by piston 30A. Rod 42A is disposed in second chamber 38A. As shown in FIG. 3, first surface 31A of piston 30A defines a wall of first fluid chamber 34A. On the other side of piston 30A is face 33A, which is the annular region between shaft 42A and outer diameter D₃. Thus, face 33A has surface area, the area between D₁ and D₃. Force on piston 30A is directly proportional to pressure and area on each face 31A, 33A. Accordingly, by increasing the size of rod 42A, the surface area of face 33A maybe reduced relative to the surface area of face 31A. The alteration of the surface area of 31A relative to surface area of 33A permits the adjustment of responsiveness of hydraulic actuators to respond to road forces differently based on the particular needs of a vehicle. If ratio of surface area of face 31A to surface area of face 33A is increased, force from piston 30A, as may be caused by road inputs say along arrow B, will have a greater effect on pressure in second fluid chamber 38A than first fluid chamber 34A. Accordingly, by adjusting this radio through the diameter of the road, each hydraulic actuator may be tuned.

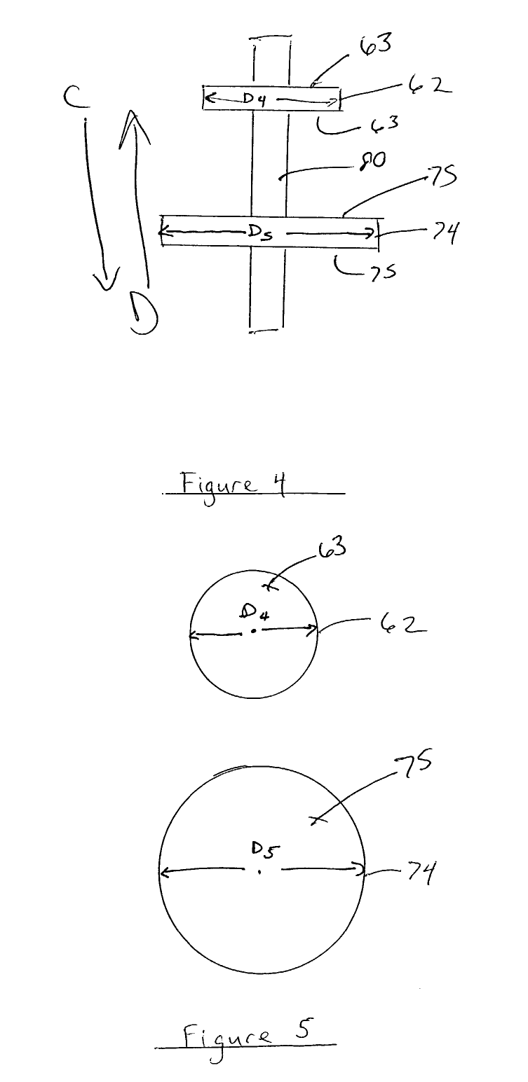

FIGS. 4 and 5 illustrate how the hydraulic suspension system may be tuned to distribute hydraulic loads between front hydraulic actuators 26A and 26B and rear hydraulic actuators 26C and 26D. As shown in FIG. 4, front linked piston 62 has diameter D4 while rear linked piston 74 has diameter D5. Diameter D4 of piston 62 is less than diameter D5 of piston 74 resulting in faces 63 having a smaller surface area than faces 75. As a result, for a given pressure, face 63 will experience a different force than face 75 resulting in a net force that will move shaft 80 and pistons 62 and 74 until forces are equalized. By altering the relative size of face 63 to face 75, the hydraulic effect of front hydraulic actuators 26A and 26B may be adjusted relative to rear hydraulic actuators 26C and 26D. As shown in FIGS. 4 and 5, there will be more roll stiffness in the front of vehicle frame 14 than the rear because of relative size of face 63 to face 75. This roll stiffness may be adjusted by altering this relative size of piston 62 to piston 74.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

What is claimed is:

1. A suspension system, comprising:
a vehicle frame having a front section and a rear section;
at least a first hydraulic actuator and a second hydraulic actuator located in one of said sections;
a piston defining a first fluid chamber and a second fluid chamber within each of said hydraulic actuators; and
a rod disposed in each said second fluid chamber, operatively connected to said piston of each of said hydraulic actuator wherein said first fluid chamber of said first hydraulic actuator is in fluid communication with said second fluid chamber of said second hydraulic actuator.

2. The suspension system of claim 1 wherein said second fluid chamber of said first hydraulic actuator is in fluid communication with said first fluid chamber of said second hydraulic actuator.

3. The suspension system of claim 1 wherein said at least first hydraulic actuator and second hydraulic actuator comprise a first front hydraulic actuator and a second front hydraulic actuator located in said front section and a first rear hydraulic actuator and a second rear hydraulic actuator located in said rear section.

4. The suspension system of claim 3 including a coupler in fluid communication with at least one of said hydraulic actuators, hydraulically linking at least one of said front hydraulic actuators to at least one of said rear hydraulic actuators.

5. The suspension system of claim 4 including a coupler valve restricting fluid communication between said coupler and one of said hydraulic actuators.

6. The suspension system of claim 4 wherein said coupler comprises a front linked chamber in fluid communication with at least one of said front hydraulic actuators and a second rear linked chamber in fluid communication with at least one of said rear hydraulic actuators, said front linked chamber comprising a front linked piston defining a first front linked subchamber and a second front linked subchamber and said rear linked chamber comprising a rear linked piston defining a first rear linked subchamber and a second rear linked subchamber wherein said front linked piston and said rear linked piston are coupled in movement.

7. The suspensions system of claim 6 wherein said first front linked subchamber is in fluid communication with said first front hydraulic actuator and said second front linked subchamber is in fluid communication with said second front hydraulic actuator and said first rear linked subchamber is in fluid communication with said first rear hydraulic actuator and said second rear linked subchamber is in fluid communication with said second rear hydraulic actuator.

8. The suspension system of claim 6 wherein said front linked piston has a different size than said rear linked piston.

9. The suspension system of claim 5 including at least one height adjustment valve for adjusting fluid levels in at least one of said hydraulic actuators.

10. A suspension system, comprising:
a vehicle frame having a front section and a rear section;
at least a first hydraulic actuator and at least a second hydraulic actuator located in one of said sections, each of said hydraulic actuators actuable along a first direction and a second direction; and
a coupler comprising a piston defining a first chamber and a second chamber, said first chamber in fluid communication with said at least first hydraulic actuator and said second chamber in fluid communication with said at least second hydraulic actuator such that actuation of both of said hydraulic actuators along the same direction results in increased fluid pressure in both chambers.

11. The suspension system of claim 10 including a valve restricting fluid communication between said coupler and one of said hydraulic actuators.

12. The suspension system of claim 11 including a control unit in communication with said valve.

13. The suspension system of claim 12 including a sensor providing data for controlling said valve to said control unit.

14. The suspension system of claim 10 wherein said at least first hydraulic actuator and second hydraulic actuator comprise a first front hydraulic actuator and a second front hydraulic actuator located in said front section and a first rear hydraulic actuator and a second rear hydraulic actuator located in said rear section.

15. The suspension system of claim 14 wherein said coupler comprises a front linked chamber in fluid communication with at least one of said front hydraulic actuators and a second rear linked chamber in fluid communication with at least one of said rear hydraulic actuators, said front linked chamber comprising a front linked piston defining a first front linked subchamber and a second front linked subchamber and said rear linked chamber comprising a rear linked piston defining a first rear linked subchamber and a second rear linked subchamber wherein said front linked piston and said rear linked piston are coupled in movement.

16. The suspension system of claim 15 wherein said front linked piston has a different size from said rear linked piston.

17. A method of tuning a suspension, comprising the steps of:
(A) providing a vehicle frame having a front section and a rear section;
(B) providing at least one front hydraulic actuator in the front section and at least one rear hydraulic actuator in the rear section;
(C) hydraulically coupling the at least one front hydraulic actuator to the at least one rear hydraulic actuator through a first piston coupled to a second piston; and
(D) altering a size of the first piston relative to a size of the second piston to adjust the hydraulic coupling between the front hydraulic actuator and the rear hydraulic actuator.

18. The method of claim 17 wherein one of the pistons is altered so that the rear piston has a greater surface area than the front piston.

19. The method of claim 17 wherein one of the pistons is altered so that the front piston has a greater surface area than the rear piston.

20. The method of claim 17 wherein altering the size of the rear piston relative to the front piston alters a roll stiffness of the vehicle frame.
